(19) United States
(12) Patent Application Publication
(10) Pub. No.: US 2018/0311982 A1
(43) Pub. Date: Nov. 1, 2018

(54) BOBBIN FOR THERMAL TRANSFER SHEET OR IMAGE-RECEIVING SHEET, ASSEMBLY OF BOBBIN AND SHEET, AND THERMAL TRANSFER PRINTER

(71) Applicant: Dai Nippon Printing Co., Ltd., Tokyo (JP)

(72) Inventors: Shigeta MORI, Tokyo (JP); Kenichi HIROTA, Tokyo (JP)

(73) Assignee: Dai Nippon Printing Co., Ltd., Tokyo (JP)

(21) Appl. No.: 15/772,220

(22) PCT Filed: Nov. 16, 2016
(86) PCT No.: PCT/JP2016/083946

§ 371 Date: Apr. 30, 2018

(30) Foreign Application Priority Data
Nov. 16, 2015 (JP) 2015-224257

(51) Int. Cl. B41J 17/24; B65H 75/10

(52) U.S. Cl. CPC B41J 17/24; B65H 75/18; B65H 75/10

(57) ABSTRACT

The present invention makes it possible to reduce the number of constituent components, and to provide a bobbin body having a smooth surface.

A bobbin for a thermal transfer sheet or an image-receiving sheet includes a cylindrical bobbin body 11, wherein a gear 12 including a plurality of teeth 13 is formed on one side end of the bobbin body 11. Each tooth 13 of the gear 12 has a polygonal shape with not less than five corners as a whole, when viewed from a lateral side.

### TECHNICAL FIELD

The present invention relates to a bobbin for a thermal transfer sheet or an image-receiving sheet, a bobbin/sheet assembly, and a thermal transfer printer.

### BACKGROUND ART

Thermal transfer printers are widely prevalent which print characters or images on an object, such as an image-receiving sheet, by using an ink ribbon (thermal transfer sheet). The ink ribbon includes a ribbon (support layer) extending in a strip shape, and an ink layer containing a dye, etc. and formed on the ribbon. The ink ribbon is mounted and wound on a bobbin.

The bobbin, on which the ink ribbon is wound, generally includes a bobbin body and a driving flange mounted on the bobbin body as a separate member from the bobbin body. However, the provision of such a driving flange, as a separate member, in a bobbin body increases the number of constituent components and increases the production cost and, in addition, involves a cumbersome operation when disposing of the bobbin.

It is conceivable to form driving irregularities in the outer surface of a bobbin body. However, when winding a ribbon on the bobbin, a rubber touch roll pressing on the ribbon may come into contact with the driving irregularities, resulting in the formation of scratches on the touch roll.

### PRIOR ART DOCUMENTS

Patent Document 1: JP2001-122523A

Patent Document 2: JP2001-150775A

### SUMMARY OF THE INVENTION

### Problems to be Solve by the Invention

The present invention has been made in view of the above situation. It is therefore an object of the present invention to provide a bobbin for a thermal transfer sheet or an image-receiving sheet, an assembly of a bobbin and a sheet, and a thermal transfer printer which can reduce the number of constituent components and can avoid scratching on a touch roller.

### Means for Solving the Problems

The present invention is a bobbin for a thermal transfer sheet or an image-receiving sheet, comprising a cylindrical bobbin body, wherein: a gear including a plurality of teeth is formed on one side end of the bobbin body; and each tooth has a polygonal shape with not less than five corners as a whole, when the bobbin body is viewed from a lateral side.

The present invention is the bobbin for a thermal transfer sheet or an image-receiving sheet, wherein one side of the polygonal shape of each tooth extends parallel to an axis line of the bobbin body.

The present invention is the bobbin for a thermal transfer sheet or an image-receiving sheet, wherein one side of the polygonal shape of each tooth has a recessed portion formed therein.

The present invention is the bobbin for a thermal transfer sheet or an image-receiving sheet, wherein each side of the polygonal shape of each tooth is curved.

The present invention is the bobbin for a thermal transfer sheet or an image-receiving sheet, wherein each corner of the polygonal shape of each tooth is chamfered.

The present invention is the bobbin for a thermal transfer sheet or an image-receiving sheet, wherein the bobbin body is provided, on a surface of the other side end thereof, with an engagement groove that performs a positioning function when mounting a flange part.

The present invention is an assembly of a bobbin and a sheet, comprising: the bobbin for a thermal transfer sheet or an image-receiving sheet as described above; and a thermal transfer sheet or an image-receiving sheet wound on the bobbin.

The present invention is the assembly of a bobbin and a sheet, further comprising a case for housing the bobbin and the thermal transfer sheet or the image-receiving sheet.

The present invention is a thermal transfer printer incorporating the assembly of a bobbin and a sheet as described above, the thermal transfer printer comprising: a mounting unit on which the assembly of a bobbin and a sheet is mounted; and a drive shaft or a brake shaft extending coaxially with the bobbin body; wherein the drive shaft or the brake shaft has, on an end surface thereof, a drive unit having a drive gear or a brake unit having a brake gear to be engaged with the gear of the bobbin body.

The present invention is a thermal transfer printer incorporating an assembly of a bobbin and a sheet, the assembly of a bobbin and a sheet including: a bobbin for a thermal transfer sheet or an image-receiving sheet having a cylindrical bobbin body, with a gear including a plurality of teeth being formed on one side end of the bobbin body; and a thermal transfer sheet or an image-receiving sheet wound on the bobbin; the thermal transfer printer comprising: a mounting unit on which the assembly of a bobbin and a sheet is mounted; and a drive unit including a drive shaft extending coaxially with the bobbin body, the drive shaft being provided, on an end surface thereof, a drive gear to be engaged with a gear of the bobbin body; or a brake unit including a brake shaft extending coaxially with the bobbin body, the brake shaft being provided, on an end surface thereof, a brake gear to be engaged with a gear of the bobbin body; wherein each tooth of the bobbin body or the drive gear or the brake gear corresponding to each tooth has a polygonal shape with not less than five corners as a whole, when the bobbin body is viewed from a lateral side.

The present invention is the thermal transfer printer, wherein each tooth of the bobbin body and the drive gear or the brake gear corresponding to each tooth has a polygonal shape as a whole, when the bobbin body is viewed from the lateral side, and the number of corners of each tooth is greater than the number of corners of the drive gear or the brake gear.

### Effects of the Invention

The present invention makes it possible to reduce the number of constituent components, and to provide a bobbin body having a smooth outer surface without any driving irregularities.

### BRIEF DESCRIPTION OF THE DRAWINGS

FIG. 1 is a side view of a bobbin for a thermal transfer sheet or an image-receiving sheet according to the present invention;

FIG. 2 is a plan view of an assembly of a sheet and bobbins;

FIG. 3 is a plan view of the assembly of a sheet and bobbins set in a thermal transfer printer;

FIG. 4A is a side view of a supply bobbin, and FIG. 4B is an enlarged view of the supply bobbin;

FIG. 5 is a cross-sectional side view of the supply bobbin;

FIG. 6 is a perspective view of the supply bobbin;

FIG. 7 is a side view of the supply bobbin having a flange part;

FIG. 8 is a side view of the flange part;

FIG. 9 is a side view of a bobbin body according to a modification example of the present invention;

FIG. 10 is a side view of a bobbin body according to a modification example of the present invention; and

FIG. 11 is an enlarged side view of a tooth part according to a modification example of the present invention.

### DESCRIPTION OF THE PREFERRED EMBODIMENTS

### Embodiment

An embodiment of the present invention will now be described with reference to the drawings.

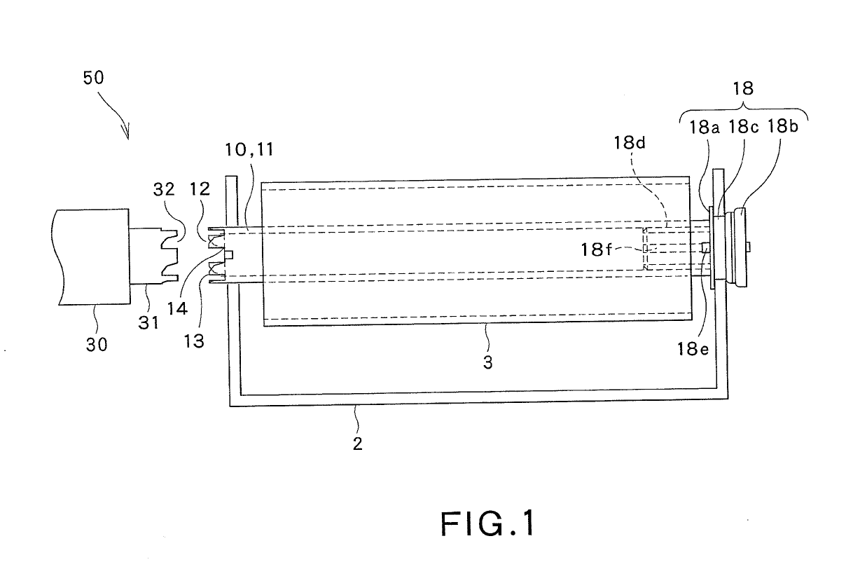

FIGS. 1 to 8 are views illustrating the embodiment of the present invention.

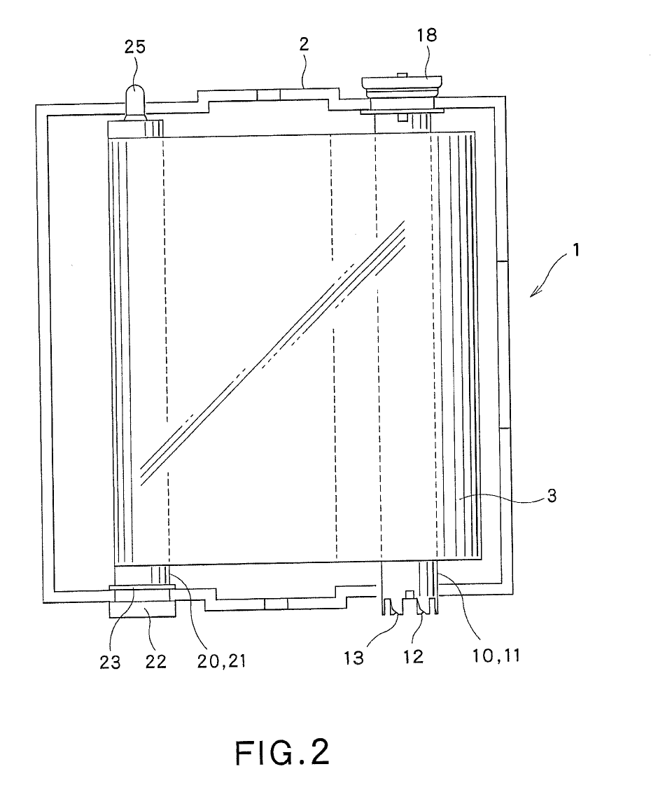

At the outset, a ribbon cartridge (assembly of bobbins and a sheet) 1 incorporating a bobbin 10 for a thermal transfer sheet or an image-receiving sheet according to the present invention is described with reference to FIG. 2.

The ribbon cartridge 1 includes a supply bobbin 10, a take-up bobbin 20, a case 2 for housing the supply bobbin 10 and the take-up bobbin 20, and an ink ribbon (thermal transfer sheet) 3 having a support layer and an ink layer, provided between the supply bobbin 10 and the take-up bobbin 20. The ink ribbon 3 is fixed on the supply bobbin 10 and on the take-up bobbin 20, respectively.

The take-up bobbin 20 of the ribbon cartridge 1 having such a structure includes a cylindrical bobbin body 21, a gear flange 22 formed integrally with the bobbin body 21 at one side end of the bobbin body 21, and a support shaft 25 formed integrally with the bobbin body 21 at the other side rend of the bobbin body 21. Herein, the “one side end of the bobbin body 21” means the whole one side end of the bobbin body 21 in an axial direction thereof, and the “other side end of the bobbin body 21” means the whole other side end of the bobbin body 21 in the axial direction.

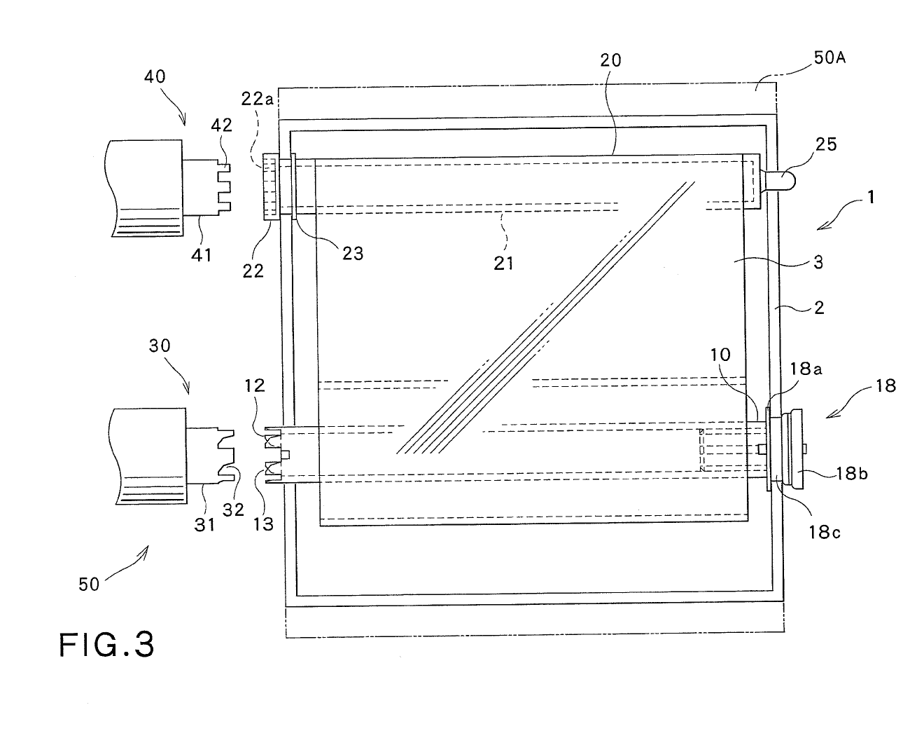

The gear flange 23 has a plurality of teeth 22a formed in an inner circumferential surface thereof. The teeth 22a formed in the inner circumferential surface are engaged with a drive unit 40 of the thermal transfer printer 50 so that the drive unit 40 drives the take-up bobbin 20 in rotation (see FIG. 3). As shown in FIG. 3, the bobbin body 21 of the take-up bobbin 20 has a circumferential projection 23 in the vicinity of the gear flange 22. A portion of the bobbin body 21, which lies between the gear flange 22 and the circumferential projection 23, is engaged with the case 2, whereby the take-up bobbin 20 is located in position along an axis line direction within the case 2.

The drive unit 40 of the thermal transfer printer 50 includes a drive shaft 41. A drive gear 42, which is engaged with the teeth 22a of the gear flange 22, is formed on an end of the drive shaft 41.

The supply bobbin 10 (bobbin for a thermal transfer sheet or an image-receiving sheet according to the present invention) of the ribbon cartridge 1 is described in detail with reference to FIGS. 1 to 8. The supply bobbin 10 includes a cylindrical bobbin body 11 having a gear 12 formed on its one side end. The gear 12 has a plurality of teeth 13 and tooth groves 14 formed between the teeth 13. As described below, the gear 12 is engaged with a brake gear 32 of a brake shaft 31 provided on a brake unit 30 of the thermal transfer printer 50.

A plurality of engagement grooves 17 are formed in the other side end of the bobbin body 11. When a flange part 18 is mounted on the other side of the bobbin body 11, engagement projections 18e of the flange part 18 are configured to be engaged with the engagement grooves 17. Herein, the “one side end of the bobbin body 11” means the whole one side end of the bobbin body 11 in an axial direction thereof, and the “other side end of the bobbin body 11” means the whole other side end of the bobbin body 11 in the axial direction.

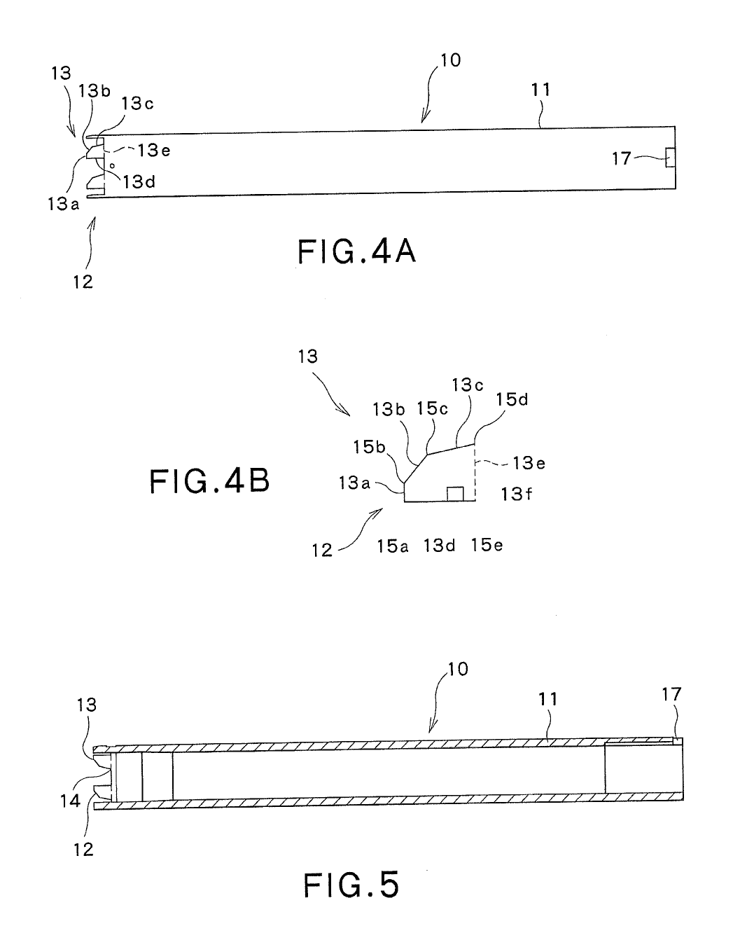

The supply bobbin 10 is described in detail with reference to FIGS. 4A, 4B to 8. As described above, the supply bobbin 10 includes the cylindrical bobbin body 11 having the gear 12 on one side end of the bobbin body 11. The gear 12 has the teeth 13 and the tooth grooves 14 formed between the teeth 13. Each tooth 13 has a pentagonal shape as a whole with five corners 15a, 15b, 15c, 15d and 15e (see FIGS. 4A and 4B), when viewed from a lateral side of the bobbin body 11. Herein, the expression “when viewed from the lateral side” means that the bobbin body 11 is viewed from the side perpendicular to the axial direction of the bobbin body 11.

As described above, each tooth 13 has a pentagonal shape with five corners 15a, 15b, 15c, 15d and 15e. A side 13a is formed between the corners 15a and 15b, a side 13b is formed between the corners 15b and 15c, a side 13c is formed between the corners 15c and 15d, a side 13d is formed between the corners 15a and 15e, and a side 13e is formed between the corners 15d and 15e. The side 13d of the sides 13a, 13b, 13c, 13d and 13e has a groove portion 13f formed therein.

The side 13e of the respective sides 13a, 13b, 13c, 13d and 13e is a virtual side that does not constitute an outer surface of the gear 12. The side 13d of the respective sides 13a, 13b, 13c, 13d and 13e is parallel to the axis line direction of the bobbin body 11. Further, the side 13c is inclined with respect to the axis line of the bobbin body 11.

The brake gear 32 to be engaged with the gear 12 has recessed portions of a shape corresponding to the pentagonal shape of each tooth 13, in order to reliably receive the respective teeth 13 of the gear 12.

In addition, each of the five corners 15a, 15b, 15c, 15d and 15e of each tooth 13 has a chamfered curved surface. Further, each of the sides 13a, 13b, 13c, 13d and 13e of each tooth 13 is curved to be outwardly convex.

Since each of the five corners 15a, 15b, 15c, 15d and 15e of each tooth 13 has a chamfered curved surface, and each of the sides 13a, 13b, 13c, 13d and 13e of each tooth 13 is curved to be outwardly convex, the tooth 13 has curved surfaces as a whole. Thus, there is no possibility that an operator who operates the bobbins 10 and 20 is scratched by the supply bobbin 10.

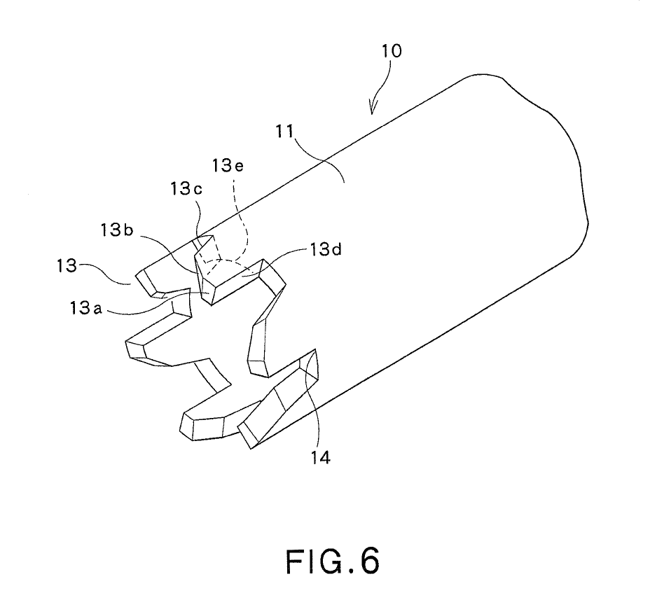

In addition, since each tooth 13 of the gear 12 has a pentagonal shape with the five corners 15a, 15b, 15c, 15d and 15e, and the brake gear 32 to be engaged with the gear 12 has the recessed portions of a shape corresponding to the pentagonal shape of each tooth 13, the respective teeth 13 of the gear 12 and the recessed portions of the brake gear 32 can be securely engaged with each other. In addition, as shown in FIG. 6, the number of teeth of the gear 12 may be greater than the number of teeth of the recessed portion of the brake gear 32, while keeping a structure of a side of the brake gear 32, which corresponds to the side 13d of the gear 12, as described below. For example, the gear 12 has six teeth and the brake gear 32 has five teeth of the recessed portion, whereby a driving force can be reliably transmitted, as well as the mounting operation can be facilitated.

The thus-constructed bobbin body 11 is disposed coaxially with the brake shaft 31 of the thermal transfer printer, and can reliably brake the bobbin body 11 by the brake shaft 31 through the brake gear 32 and the gear 12.

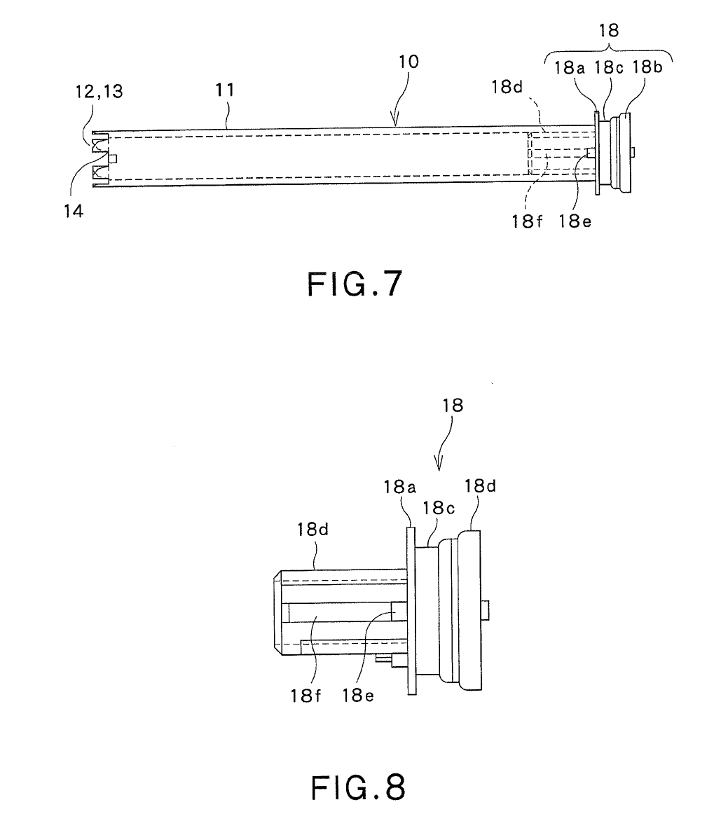

Next, the flange prat 18 to be mounted on the bobbin body 11 is described. As shown in FIGS. 7 and 8, the flange part 18 is to be mounted on the other side end of the bobbin body 11, and includes a first flange 18a, a second flange 18b, and an engagement portion 18c which is formed between the first flange 18a and the second flange 18b and is engaged with the case 2. A cylindrical portion 18d, which is to be inserted into the bobbin body 11, is coupled to the first flange 18a.

In addition, the engagement projections 18e, which are to be engaged with the engagement grooves 17 of the bobbin body 11, are provided on the cylindrical portion 18d of the flange part 18 at positions adjacent to the first flange 18a.

The cylindrical portion 18d of the flange part 18 is provided with axial ribs 18f whose projecting height is lower than the height of the engagement projections 18e and which extend in the axial direction. The axial ribs 18f of the flange part 18 are configured to be engaged with axial grooves (not shown) formed in the inner surface of the bobbin body 11.

The thus-constructed flange part 18 is formed as a separate member from the bobbin body 1, and is mounted on the bobbin body 11. In this manner, the supply bobbin 10 is constructed.

The flange part 18 has a built-in RFID for identifying the type of the ink ribbon 3 to be supplied.

Next, an operation of the embodiment as structured above is described.

Firstly, the supply bobbin 10 with the ink ribbon 3 wound thereon, and the take-up bobbin 20 are prepared. When the ink ribbon 3 is wound on the supply bobbin 10, the ink ribbon 3 is kept pressed against the supply bobbin 10 by means of a touch roller.

Then, the supply bobbin 10 and the take-up bobbin 20 are set in the case 2, thereby obtaining the ribbon cartridge (the assembly of bobbins and a sheet) 1 including the case 2, the supply bobbin 10 with the ink ribbon 3 wound thereon, and the take-up bobbin 20.

Then, the ribbon cartridge 1 is mounted on a mounting unit 50A of the thermal transfer printer 50. In this case, the take-up bobbin 20 of the ribbon cartridge 1 aligns coaxially with the drive shaft 41 of the drive unit 40 of the thermal transfer printer 50, while the supply bobbin 10 aligns coaxially with the brake shaft 31 of the brake shaft 30 of the thermal transfer printer.

Then, the drive unit 40 is pressed against the take-up bobbin 20, whereby the drive gear 42 of the drive unit 40 is engaged with the gear flange 22 (the teeth 22a formed in the inner circumferential surface) of the take-up bobbin 20.

Similarly, the brake unit 30 is pressed against the supply bobbin 10, whereby the brake gear 32 formed on the brake shaft 31 of the brake unit 30 is engaged with the gear 12 of the supply bobbin 10.

At this time, since the teeth 13 of the gear 12 each have a pentagonal shape when viewed from the lateral side, the brake gear 32 of the brake unit 30 and the gear 12 of the supply bobbin 10 can be engaged with each other easily and simply, only by pressing the brake unit 30 against the supply bobbin 10.

Then, the take-up bobbin 20 is driven by the drive unit 40, and the supply bobbin 10 is braked by a brake (not shown) built in the brake unit 30. In this manner, the ink ribbon 3 wound on the supply bobbin 10 is supplied. Then, the ink ribbon 3, which extends between the supply bobbin 10 and the take-up bobbin 20, is heated by a thermal head (not shown), whereby the ink of the ink ribbon 3 is transferred onto an image-receiving sheet (not shown). A thermal transfer operation is performed in this manner.

As described above, according to this embodiment, since the gear 12 including the teeth 13 is formed on one side end of the bobbin body 11 of the supply bobbin 10, the brake gear 32 of the brake unit 30 of the thermal transfer printer 50 can be directly engaged with the gear 12. Thus, the driving force in the rotational direction from the brake shaft 31 of the brake unit 30 can be directly transmitted to the bobbin body 11.

Accordingly, there is no need to provide the bobbin body 11 with a flange that is engaged with the brake shaft 31, resulting in reduction of the number of components. Furthermore, there is no need to provide driving irregularities to be engaged with the brake shaft 31 of the brake unit 30, on the outer surface of the bobbin body 11. The outer surface of the bobbin body 11 can therefore be a smooth surface. This can avoid scratching on a rubber touch roller which is used to wind the ink ribbon 3 on the supply bobbin 10.

In addition, since the teeth 13 of the gear 12 each have a pentagonal shape as a whole when viewed from the lateral side, the gear 12 and the brake gear 32 of the brake unit 30 can be engaged with each other easily and simply, only by pressing the brake unit 30 against the gear 12.

### MODIFICATION EXAMPLES

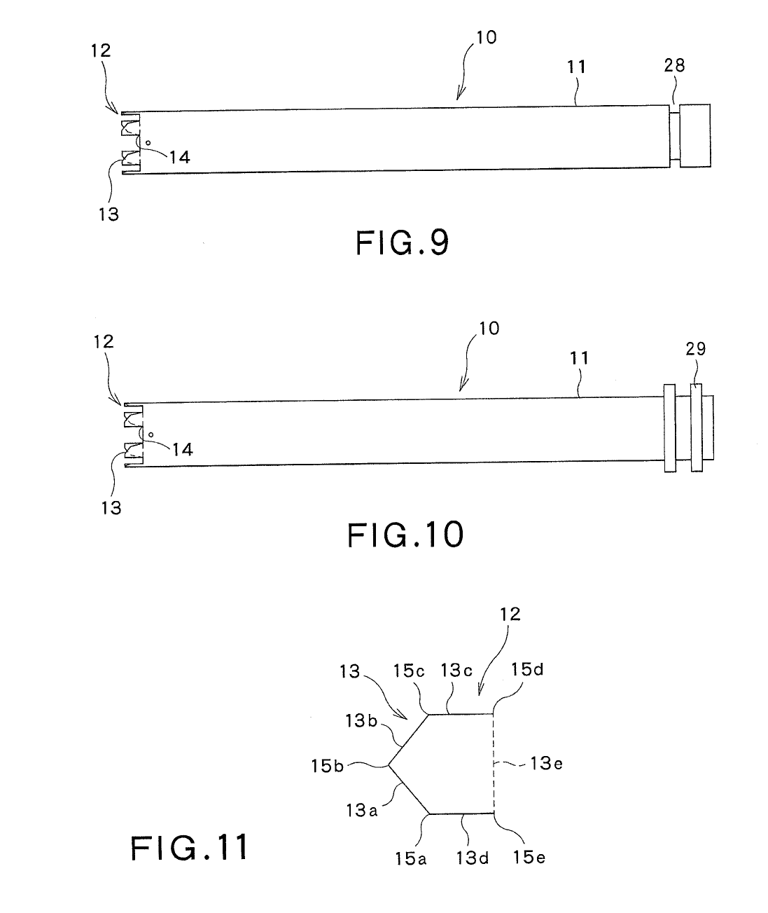

Next, modification examples of the present invention are described with reference to FIGS. 9 and 10.

In the embodiment shown in FIGS. 1 to 8, the flange part 18 is mounted on the other side end of the bobbin body 11 of the supply bobbin 10. However, the present invention is not limited thereto. For example, as shown in FIG. 9, it is possible to provide a circumferential groove 28, which is engaged with the case 2 to perform positioning of the supply bobbin 10, on the other side end of the bobbin body 11.

As shown in FIG. 9, similarly to the embodiment shown in FIGS. 1 to 8, the gear 12, which includes the teeth 13 and the tooth grooves 14 formed between the teeth 13, is formed on the one side end of the bobbin body 11.

As shown in FIG. 9, since the supply bobbin 10 consists solely of the bobbin body 11 and has no flange part, the number of constituent components can be further reduced.

In addition, in the embodiment shown in FIGS. 1 to 8, the flange part 18 is mounted on the other side of the bobbin body 11 of the supply bobbin 10. However, the present invention is not limited thereto. For example, as shown in FIG. 10, it is possible to provide a pair of circumferential projections 29, which are engaged with the case 2 to perform positioning of the supply bobbin 10, on the other side end of the bobbin body 11.

As shown in FIG. 10, similarly to the embodiment shown in FIGS. 1 to 8, the gear 12, which includes the teeth 13 and the tooth grooves 14 formed between the teeth 13, is formed on the one side end of the bobbin body 11.

As shown in FIG. 10, since the supply bobbin 10 consists solely of the bobbin body 11 and has no flange part, the number of constituent components can be further reduced.

In the above-described embodiment, the ink ribbon (thermal transfer sheet) 3 is wound on the supply bobbin 10 and the take-up bobbin 20. However, it is possible to wind an image-receiving sheet on the supply bobbin 10 and the on the take-up bobbin 20 in order that the supply bobbin 10 and the take-up bobbin 20 can be used as bobbins for an image-receiving sheet.

Next, a modification example of each tooth 13 of the gear 12 is described with reference to FIG. 11.

In the above-described embodiment, each tooth 13 has a pentagonal shape, the side 13d of each tooth 13 is parallel to the axis line of the bobbin body 11, and the side 13c is inclined with respect to the axis line of the bobbin body 11. However, as shown in FIG. 11, each tooth 13 may have a pentagonal shape, and both the sides 13c and 13d of each tooth 13 may be parallel to the axis line of the bobbin body 11. Each tooth 13 has five corners. The corners 15a, 15b and 15c each have a chamfered curved surface. Further, the sides 13a and 13b are curved outwardly.

In FIG. 11, since both the sides 13d and 13c of each tooth 13 are parallel to the axis line of the bobbin body 11, the gear 12 and the brake gear 32 can be securely joined to each other so as to achieve reliable transmission between the gear 12 and the brake gear.

Alternatively, although the gear 12 of the supply bobbin 10 has the teeth 13 of a pentagonal shape, the present invention is not limited thereto, and the take-up bobbin 20 may have teeth of a pentagonal shape. In addition, the supply bobbin 10 or the take-up bobbin 20 may have teeth of a pentagonal shape, or the brake gear 30 or the drive gear 40 of the thermal transfer printer 50 may have teeth of a pentagonal shape. The number of corners of the tooth of the supply bobbin 10 or the take-up bobbin 20 may be greater than the number of corners of the brake gear 30 or the drive gear 40.

### DESCRIPTION OF THE REFERENCE NUMERALS

1 ribbon cartridge
2 case
3 thermal transfer sheet (ink ribbon)
10 supply bobbin
11 bobbin body
12 gear
13 tooth
13a, 13b, 13c, 13d, 13e side
31f groove portion
15a, 15b, 15c, 15d, 15e corner
17 engagement groove
20 take-up bobbin
21 bobbin body
22 gear flange
30 brake unit
31 brake shaft
32 brake gear
40 drive unit
41 drive shaft
42 drive gear
50 thermal transfer printer
50A mounting unit

1-11. (canceled)

12. A thermal transfer printer incorporating an assembly of a bobbin and a sheet, the assembly of a bobbin and a sheet including: a bobbin for a thermal transfer sheet or an image-receiving sheet having a cylindrical bobbin body, with a gear including a plurality of teeth being formed on one side end of the bobbin body; and a thermal transfer sheet or an image-receiving sheet wound on the bobbin; the thermal transfer printer comprising:
a mounting unit on which the assembly of a bobbin and a sheet is mounted; and
a drive unit including a drive shaft extending coaxially with the bobbin body, the drive shaft being provided, on an end face thereof, a drive gear to be engaged with a gear of the bobbin body; or a brake unit including a brake shaft extending coaxially with the bobbin body, the brake shaft being provided, on an end face thereof, a brake gear to be engaged with a gear of the bobbin body;
wherein:
each tooth of the bobbin body or the drive gear or the brake gear corresponding to each tooth has a polygonal shape with not less than five corners as a whole, when the bobbin body is viewed from a lateral side; and
the number of corners of each tooth is greater than the number of corners of the drive gear or the brake gear.

13. The thermal transfer printer according to claim 12,
one side of the polygonal shape of each tooth extends parallel to an axis line of the bobbin body.

14. The thermal transfer printer according to claim 12, wherein
one side of the polygonal shape of each tooth has a groove portion formed therein.

15. The thermal transfer printer according to claim 12, wherein
each side of the polygonal shape of each tooth is curved.

16. The thermal transfer printer according to claim 12, wherein
each corner of the polygonal shape of each tooth is chamfered.

17. The thermal transfer printer according to claim 12, wherein
the bobbin body is provided, on a surface of the other side end thereof, with an engagement groove that performs a positioning function when mounting a flange part.

18. The thermal transfer printer according to claim 12, further comprising a case for housing the bobbin and a thermal transfer sheet or an image-receiving sheet.
